(19) United States
(12) Patent Application Publication
(10) Pub. No.: US 2015/0142360 A1
(43) Pub. Date: May 21, 2015

(54) METROLOGICAL APPARATUS AND A METHOD OF DETERMINING A SURFACE CHARACTERISTIC OR CHARACTERISTICS

(71) Applicant: Taylor Hobson Limited, Leicester, Leicestershire (GB)

(72) Inventor: Andrew Douglas Bankhead, Leicester (GB)

(21) Appl. No.: 14/415,297

(22) PCT Filed: Jul. 19, 2013
(86) PCT No.: PCT/GB2013/051936

§ 371 Date: Jan. 16, 2015

(30) Foreign Application Priority Data
Jul. 19, 2012 (GB) 1212827.8

(51) Int. Cl. G01B 11/24; G01B 9/02

(52) U.S. Cl. CPC G01B 11/2441; G01B 9/0209
USPC 702/85; 356/511

(57) ABSTRACT

A metrological apparatus includes an optical measurement system (1) such as a coherence scanning interferometer operable to obtain measurement data representative of a surface of a workpiece and a rotation device (15) to effect relative rotation between the optical measurement system and the workpiece about a measurement axis to enable a plurality of measurement data sets to be obtained with each measurement data set being obtained by the optical measurement system at a respective one of a number of different relative rotational orientation s of the optical measurement system and the workpiece. A data corrector (323) is provided to obtain correction data to enable correction of a measurement data set. The correction data may be an average of the plurality of measurement data sets.

This invention relates to metrological apparatus and a method of determining a surface characteristic or surface characteristics of a surface such as a conical or frusto-conical surface, for example a valve seat.

A surface may have various surface characteristics. Surface form represents the lowest frequency surface variation and generally has a wavelength of the order of the scale of the surface whilst surface texture or surface roughness represents higher frequency surface variation. For many nominally rotationally symmetric surfaces their roundness (or out of roundness) is important. For example, in the case of a valve such as a fuel injector valve where a ball or needle seals against a conical (more generally frusto-conical) seating face or surface of the valve in the valve's closed condition, out-of-roundness of the seating face of the conical surface may result in the seal not being made properly with the result that the valve leaks.

Embodiments of the present invention enable orientation-dependent effects in roundness resulting from, for example, optical distortions within an optical system of an interferometer, such as, for example, a broadband scanning or scanning white light interferometer, to be reduced or ameliorated.

An embodiment of the present invention provides a metrological apparatus for determining a surface characteristic of a surface of a workpiece, the metrological apparatus comprising: an optical measurement system to obtain measurement data representative of a surface of a workpiece; a rotation device to effect relative rotation between the optical measurement system and the workpiece about a measurement axis to enable a plurality of measurement data sets to be obtained with each measurement data set being obtained by the optical measurement system at a respective one of a number of different relative rotational orientations of the optical measurement system and the workpiece; a correction data obtainer to use the plurality of measurement data sets to obtain correction data to enable correction of a measurement data set.

The metrological apparatus may comprise a correction data applier configured to use the correction data to correct the measurement data set.

The metrological apparatus may further comprise a low pass filter configured to smooth the measurement data to remove features of surface roughness.

The correction data obtainer may be arranged to average the plurality of measurement data sets to obtain the correction data.

The metrological apparatus may further comprise a correction data remover to remove the correction data from at least one measurement data set to obtain corrected measurement data. The at least one measurement data set may or may not be one of the plurality of measurement data sets.

The surface characteristic may be a roundness of the surface.

The measurement data may comprise roundness measurement data.

The metrological apparatus may further comprise a correction data expander to expand the correction data to enable the correction data to be used for workpiece surfaces of different dimensions. The correction data expander may be configured to adjust the correction data to correspond to the dimensions of the workpiece surface, for example when correction data is a different dimension to the measured workpiece the correction data expander may adjust, by scaling, the correction data to be the same dimension as the measured workpiece.

In an embodiment the measurement data may comprise a plurality of pixels representing measurements of locations on the workpiece. The correction data expander may apply the correction data to each pixel of the measurement data for the workpiece according to the location of the pixel of the measurement data, and the correction data of a corresponding location. The location of the pixel may comprise an angle, e.g. in the sense of a polar co-ordinate, with respect to a centre of rotation of the data and/or the workpiece.

The metrological apparatus may further comprise a form data remover to fit a form of the measurement data obtained by the optical measurement system and to remove the fitted form to provide the measurement data set.

The form data remover may be configured to fit a model of expected surface form to each of the plurality of measurement data sets to obtain fitted form data, and to adjust the measurement data set based on the fitted form data. Adjusting the measurement data set may comprise subtracting the fitted form data, for example to provide a form removed data set.

The correction data obtainer may be arranged to average a plurality of adjusted form removed measurement data sets. In another possibility the correction data obtainer may be configured to average the measurement data set before the measurement data set is adjusted based on the fitted form data.

The rotation device may comprise a turntable on which the workpiece is mounted during a measurement operation.

The optical measurement system may be an interferometric measurement system, for example the optical measurement system is a coherence scanning interferometric measurement system.

Aspects and examples of the present invention are set out in the appended claims.

The optical measurement system may comprise: a light director to direct light along a sample path towards a region of the workpiece surface and along a reference path towards a reference surface such that light reflected by the region of the workpiece surface and light reflected by the reference surface interfere; a mover to effect relative movement between the workpiece surface and the reference surface along a measurement path; a sensor operable to sense light representing the interference fringes produced by workpiece surface regions during the relative movement; and a controller to carry out a measurement operation by causing the mover to effect the relative movement while the sensor senses light intensity at intervals to provide, for each of a plurality of workpiece surface regions, a series of intensity values representing interference fringes produced by that workpiece surface region during the relative movement.

An embodiment provides a metrological apparatus for determining surface roundness, the metrological apparatus comprising: an optical measurement system to obtain measurement data comprising roundness data for at least a part of a surface of a workpiece; a rotation device to effect relative rotation between the optical measurement system and the workpiece about a measurement axis to enable a plurality of measurement data sets each comprising roundness data to be obtained for the at least a part of the workpiece surface, with each measurement data set being obtained by the optical measurement system at a respective one of a number of different relative rotational orientations of the optical measurement system and the workpiece; and a data averager to average the plurality of measurement data sets to obtain average measurement data to enable correction of a measurement data set for at least part of a surface.

An embodiment provides a metrological apparatus for providing roundness measurement data for a sample surface, the metrological apparatus comprising: a light director to direct light along a sample path towards a region of a sample surface and along a reference path towards a reference surface such that light reflected by the region of the sample surface and light reflected by the reference surface interfere; a mover to effect relative movement between the sample surface and the reference surface along a measurement path; a sensor operable to sense light representing the interference fringes produced by sample surface regions during the relative movement; a controller to carry out a measurement operation by causing the mover to effect the relative movement while the sensor senses light intensity at intervals to provide, for each of a plurality of sample surface regions, a series of intensity values representing interference fringes produced by that sample surface region during the relative movement such that a said series of intensity values has a coherence peak at a position along the measurement path representing a location of zero path difference between the reference path and the sample path for the corresponding sample surface region; a surface height determiner to determine surface height data representing the relative surface heights of sample surface regions on the basis of the locations along the measurement path of their respective coherence peaks so as to provide a measurement data set comprising roundness measurement data; a rotation device to effect relative rotation between the optical measurement system and the sample surface about a measurement axis to enable a plurality of said measurement data sets to be obtained each comprising roundness data, with each measurement data set being obtained by the optical measurement system at a respective one of a number of different relative rotational orientations of the optical measurement system and the workpiece; and

a correction data obtainer to use the plurality of measurement data sets to obtain correction data to enable correction of a measurement data set.

An embodiment provides a metrological apparatus for determining a surface characteristic, for example roundness, of a surface of a workpiece, the metrological apparatus comprising: an optical measurement system to obtain measurement data representative of a surface characteristic, for example roundness, of a surface of a workpiece or component; and a data processor to remove from the measurement data correction data obtained by apparatus as set out above.

The metrological apparatus may comprise an average data remover to remove the average measurement data from at least one measurement data set to obtain corrected measurement data.

The metrological apparatus may comprise an average data expander to expand the average data to enable the average data to be used with workpiece surfaces of different dimensions.

In an embodiment a surface form remover is provided to remove a sample surface form from a said measurement data set to leave data indicative of any out-of-roundness of the surface of a section through the surface at one or more locations along an axis of the surface;

An embodiment provides a method of determining a surface characteristic of a surface of a workpiece, the method comprising: using an optical measurement system to carry out a plurality of measurement operations on a surface of a workpiece and effecting relative rotation between the optical measurement system and the workpiece about a measurement axis between measurement operations to obtain a plurality of measurement data sets with each measurement data set being obtained at a respective one of a number of different relative rotational orientations of the optical measurement system and the workpiece; using the plurality of measurement data sets to obtain correction data to enable correction of a measurement data set.

The method may comprise using the correction data to correct a measurement data set.

In an embodiment, obtaining the plurality of measurement data sets may comprise fitting a model of expected surface form to each of the plurality of measurement data sets to obtain corresponding fitted form data, and to adjust each measurement data set based on the corresponding fitted form data.

The method may comprise fitting a form of the measurement data obtained by the optical measurement system and removing the fitted form to provide the measurement data set.

The method may comprise using the plurality of measurement data sets to obtain correction data comprises averaging the plurality of adjusted measurement data sets.

The method may comprise removing the correction data from at least one measurement data set to obtain corrected measurement data.

In an embodiment the at least one measurement data set may be one of the plurality of measurement data sets.

In an embodiment the at least one measurement data set may not be one of the plurality of measurement data sets.

In an embodiment the surface characteristic may be the roundness of the surface.

In an embodiment the measurement data may comprise roundness measurement data.

The method may comprise a correction data expander to expand the correction data to enable the correction data to be used for workpiece surfaces of different dimensions.

The method may comprise fitting a model of expected surface form to each of the plurality of measurement data sets obtained by the optical measurement system to obtain fitted form data, and to adjust the measured data set based on the fitted form data.

In an embodiment a rotation device may comprise a turntable on which the workpiece is mounted during a measurement operation.

In an embodiment the optical measurement system may be an interferometric measurement system.

In an embodiment the optical measurement system may be a coherence scanning interferometric measurement system.

In an embodiment using an optical measurement system to carry out a measurement operation may comprise: directing light along a sample path towards a region of the workpiece surface and along a reference path towards a reference surface such that light reflected by the region of the workpiece surface and light reflected by the reference surface interfere; effecting relative movement between the workpiece surface and the reference surface along a measurement path; and sensing light representing the interference fringes produced by workpiece surface regions at intervals during the relative movement to provide, for each of a plurality of workpiece surface regions, a series of intensity values representing interference fringes produced by that workpiece surface region during the relative movement.

The method may comprise determining surface roundness in which the measurement data comprises roundness data for at least part of a surface of the workpiece; in which using the plurality of measurement data sets comprises: averaging the plurality of measurement data sets to obtain average measurement data to enable correction of a measurement data set for at least part of a surface.

In an embodiment using an optical measurement system to carry out a measurement operation may comprise: directing light along a sample path towards a region of the workpiece surface and along a reference path towards a reference surface such that light reflected by the region of the workpiece surface and light reflected by the reference surface interfere;

effecting relative movement between the workpiece surface and the reference surface along a measurement path; and sensing light representing the interference fringes produced by workpiece surface regions at intervals during the relative movement to provide, for each of a plurality of workpiece surface regions, a series of intensity values representing interference fringes produced by that workpiece surface region during the relative movement.

In an embodiment carrying out a said plurality of measurement operations may comprise: directing light along a sample path towards a region of the workpiece surface and along a reference path towards a reference surface such that light reflected by the region of the workpiece surface and light reflected by the reference surface interfere, effecting relative movement between the workpiece surface and the reference surface along a measurement path, and

sensing light representing the interference fringes produced by workpiece surface regions at intervals during the relative movement to provide, for each of a plurality of workpiece surface regions, a series of intensity values representing interference fringes produced by that workpiece surface region during the relative movement such that a said series of intensity values has a coherence peak at a position along the measurement path representing a location of zero path difference between the reference path and the sample path for the corresponding sample surface region; for each measurement operation determining surface height data representing the relative surface heights of sample surface regions on the basis of the locations along the measurement path of their respective coherence peaks so as to provide a measurement data set comprising roundness measurement data.

The method may comprise removing a workpiece surface form from a said measurement data set to leave data indicative of any out-of-roundness of the surface of a section through the surface at one or more locations along an axis of the surface;

The method may comprise using an optical measurement system to obtain measurement data representative of a surface characteristic, for example roundness, of a surface of a workpiece or component; and a removing from the measurement data correction data obtained by a method described above.

An embodiment provides a data processor for a metrological apparatus, the data processor being configured: to receive data for a plurality of measurement operations of a surface of a workpiece carried out by an optical measurement system with relative rotation between the optical measurement system and the workpiece about a measurement axis between measurement operations; to determine for each measurement operation a corresponding measurement data set such that each measurement data set corresponds to a respective different one of a number of different relative rotational orientations of the optical measurement system and the workpiece; and to use the plurality of measurement data sets to obtain correction data to enable correction of a measurement data set.

In an embodiment the data processor may be configured to average the plurality of measurement data sets to obtain the correction data.

In an embodiment the data processor may be configured to remove the correction data from at least one measurement data set to obtain corrected measurement data.

In an embodiment the at least one measurement data set may be one of the plurality of measurement data sets.

In an embodiment the at least one measurement data set may not be one of the plurality of measurement data sets.

In an embodiment the surface characteristic may be the roundness of the surface.

In an embodiment the data processor may be configured to expand the correction data to enable the correction data to be used for workpiece surfaces of different dimensions.

In an embodiment the data processor may be configured to fit a model of expected surface form to each of a plurality of measurement data sets, to obtain corresponding fitted form data, and to adjust each measurement data set based on the corresponding fitted form data.

In an embodiment the data processor may be configured to fit a form of the measurement data obtained by the optical measurement system and to remove the fitted form to provide the measurement data set.

In an embodiment there is provided method of determining a surface characteristic, the method comprising: using an optical measurement system of a first metrological apparatus to carry out a plurality of measurement operations on a surface of a first workpiece and effecting relative rotation between the optical measurement system and the first workpiece about a measurement axis between measurement operations to obtain a plurality of measurement data sets with each measurement data set being obtained at a respective one of a number of different relative rotational orientations of the optical measurement system and the first workpiece; using the plurality of measurement data sets to obtain first correction data for the first metrological apparatus; using the first metrological apparatus to carry out a measurement of a calibration sample, and correcting that measurement using the first correction data to provide calibration data for the calibration sample using a second metrological apparatus to measure the calibration sample to obtain second measurement data; and determining second correction data for the second metrological apparatus based on the second measurement data and the calibration data to enable a surface characteristic of a second workpiece to be determined by the second metrological apparatus.

In an embodiment determining second correction data comprises subtracting the first correction data from the first measurement data. In an embodiment the calibration sample is cone shaped. In an embodiment the calibration sample comprises is elliptical, eccentric, or otherwise deviates from roundness by more than the measurement accuracy of the first or second metrological apparatus. In an embodiment the calibration sample carries an orientation identifier reference mark for orienting the calibration sample, the method further comprising aligning the calibration sample with respect to the second instrument based on the orientation identifier.

In an embodiment the orientation identifier comprises at least one of a reference mark, a shaped mounting, wherein the shape has a known asymmetry, and a known non-rotationally symmetric component of the calibration sample.

An embodiment provides a metrological apparatus an optical measurement system such as a coherence scanning interferometer to obtain measurement data representative of a surface of a workpiece and a rotation device to effect relative rotation between the optical measurement system and the workpiece about a measurement axis to enable a plurality of measurement data sets to be obtained with each measurement data set being obtained by the optical measurement system at a respective one of a number of different relative rotational orientations of the optical measurement system and the workpiece. A data corrector is provided to obtain correction data to enable correction of a measurement data set. The correction data may be an average of the plurality of measurement data sets.

An embodiment provides a non-transitory computer program product, such as a non-transitory storage medium, storing program instructions that when executed by computing apparatus cause the computing apparatus to carry the method.

Embodiments of the present invention will now be described, by way of example, with reference to the accompanying drawings, in which:

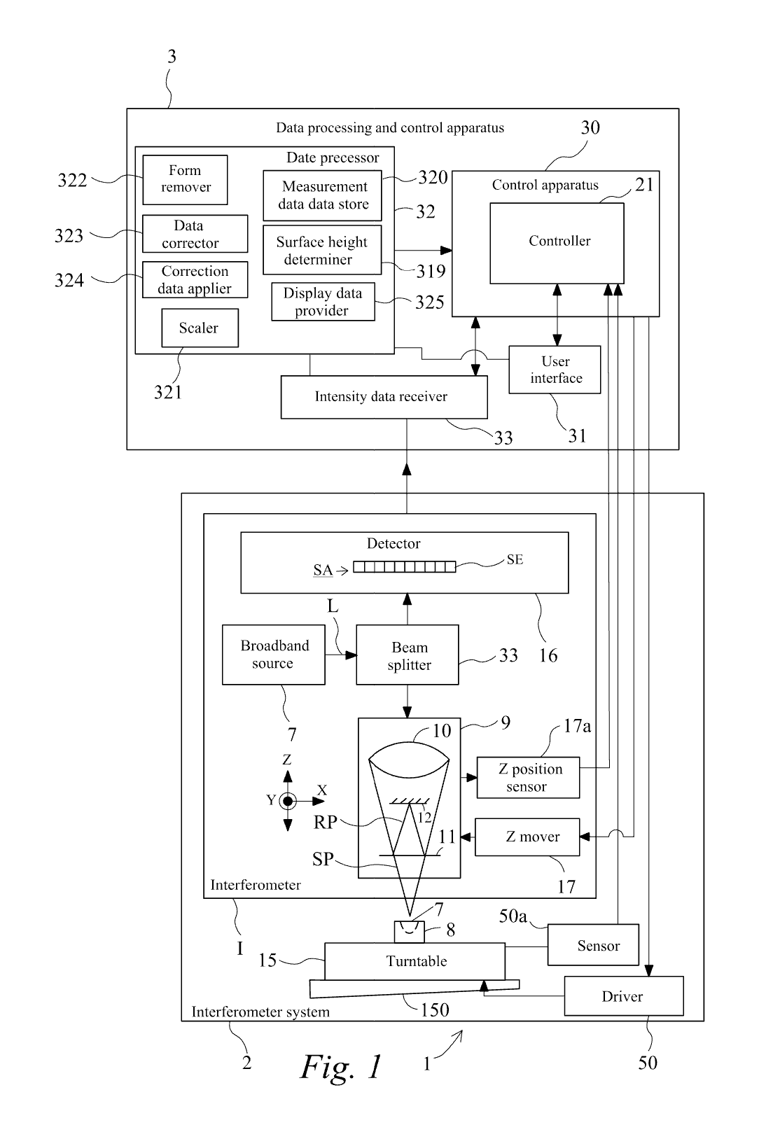

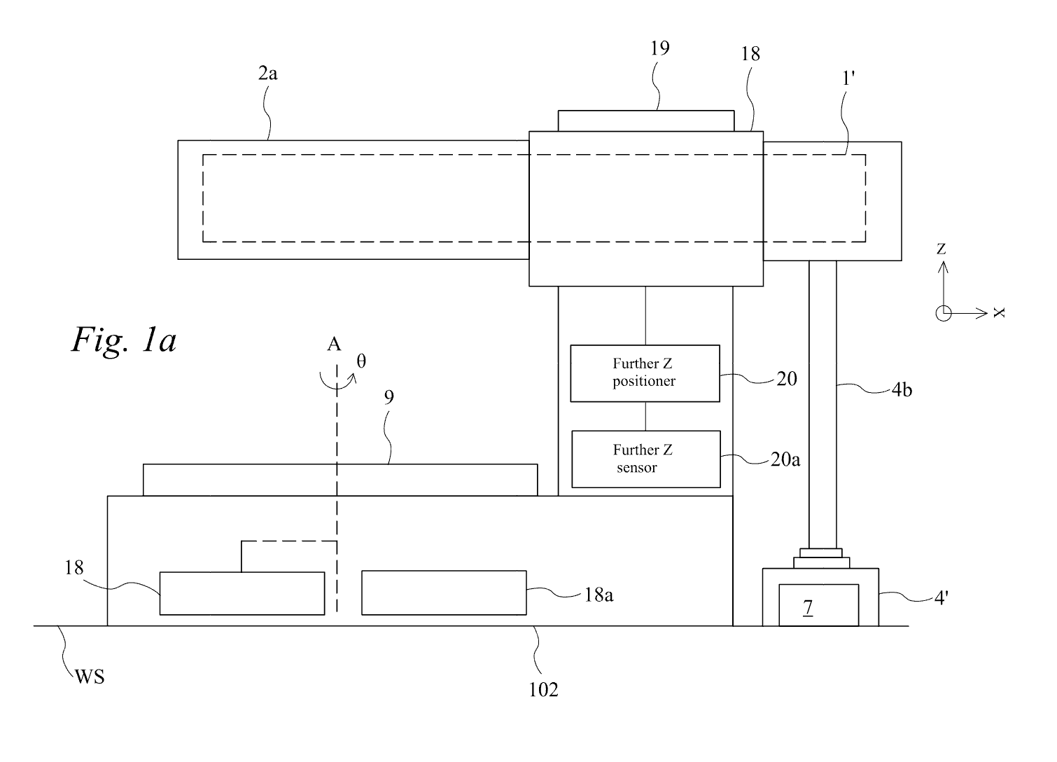

FIG. 1 shows a schematic block diagram of metrological apparatus for determining a surface characteristic;

FIG. 1a shows a simplified, diagrammatic side view, part cutaway, of an example of the apparatus shown in FIG. 1;

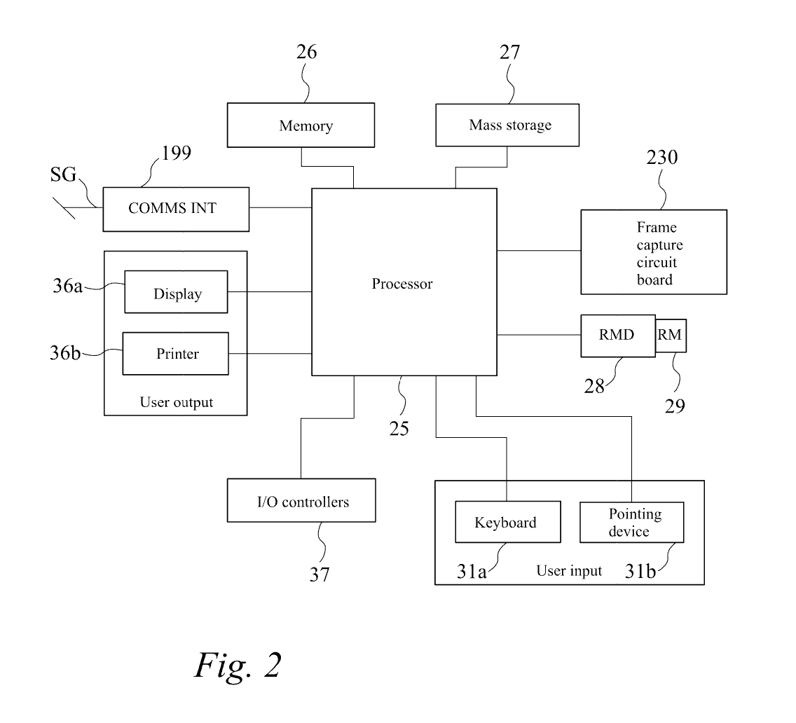

FIG. 2 shows a functional block diagram of computing apparatus that may be configured to provide the data processing and control apparatus shown in FIG. 1;

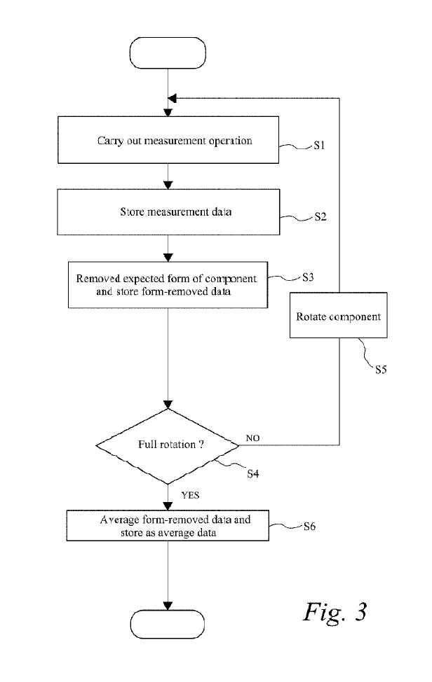

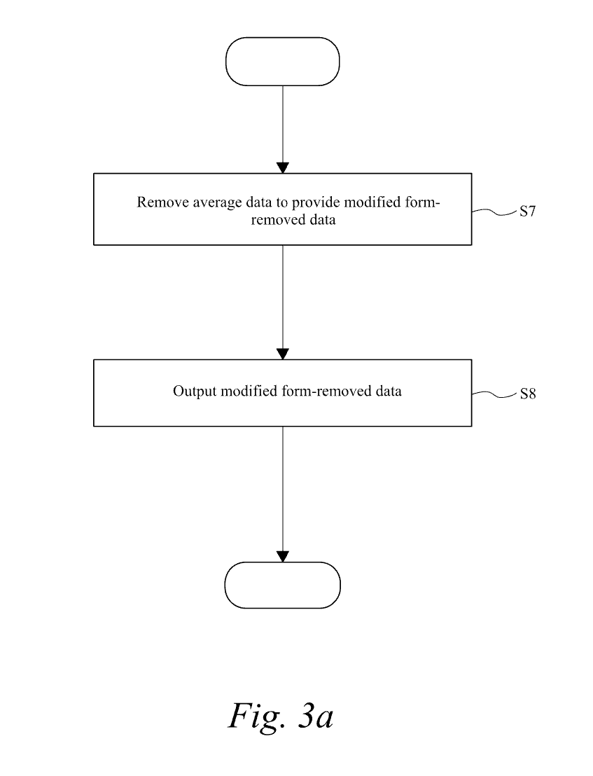

FIG. 3 shows a flow chart illustrating processes to determine average data;

FIG. 3a shows a flow chart illustrating processes that may be carried out after determination of the average data;

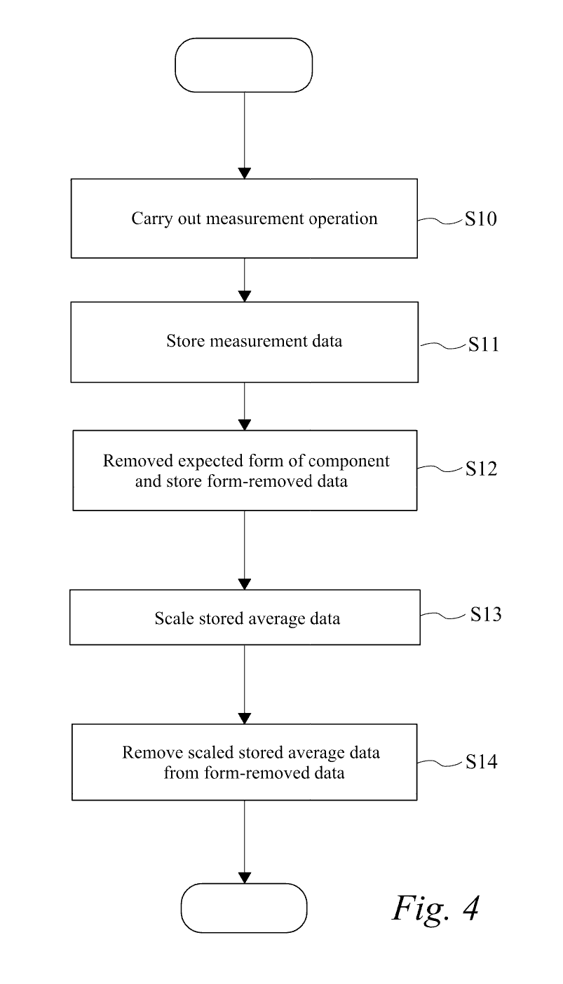

FIG. 4 shows a flow chart illustrating processes carried out to correct measurement data;

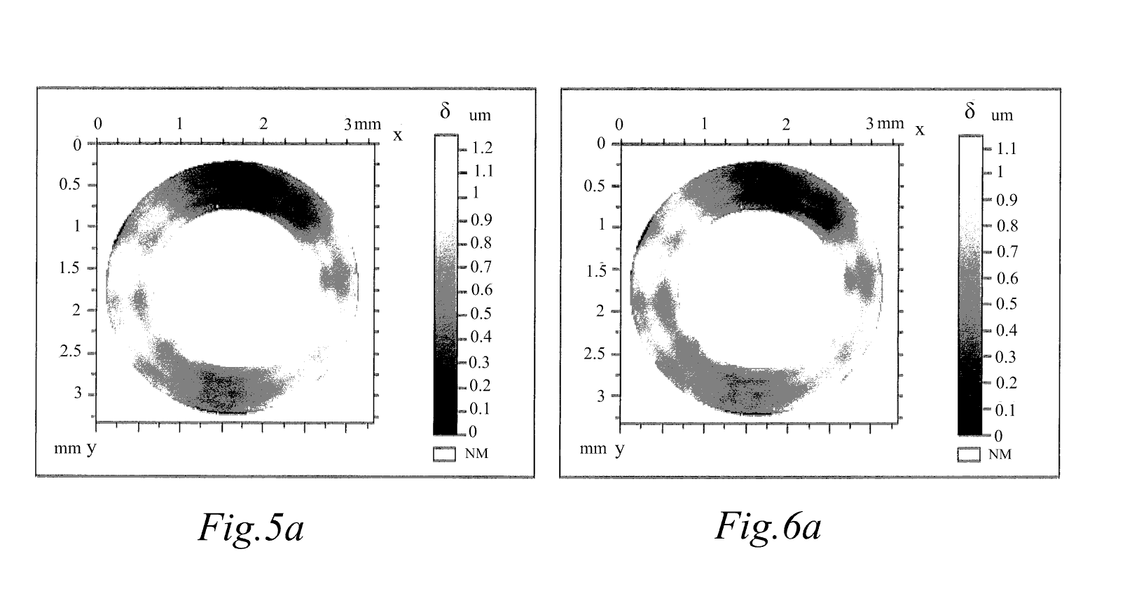

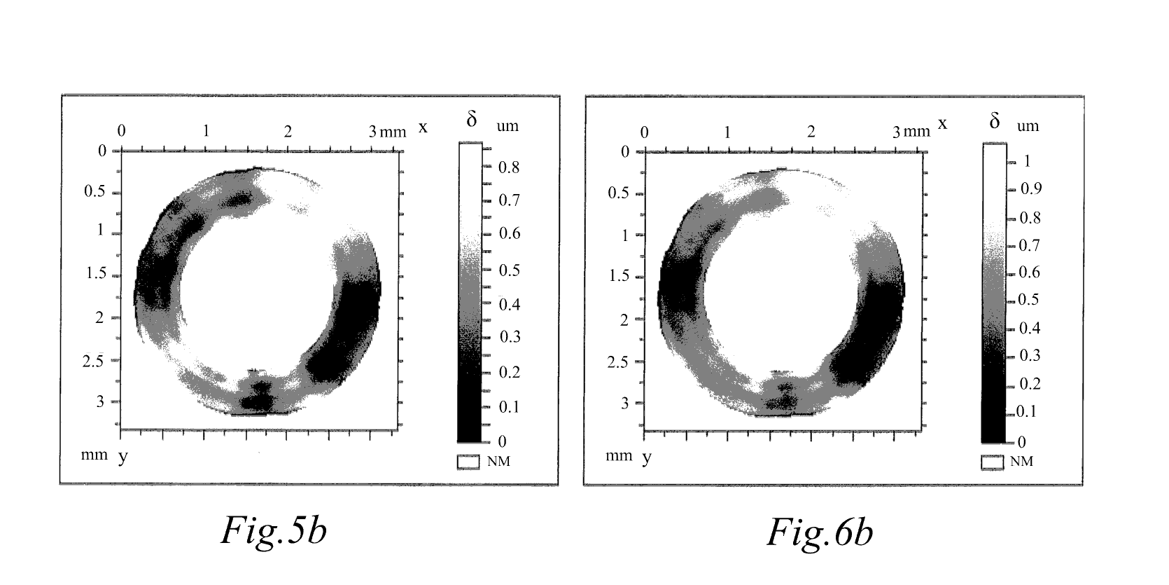

FIGS. 5a and 5b show gray scale images representing annular data plots of form-removed data produced with a workpiece at rotation angles of 45° and 135°, respectively, with no correction;

FIGS. 6a and 6b show gray scale images representing annular data plots of form-removed data produced with a workpiece at rotation angles of 45° and 135°, respectively, after correction; and

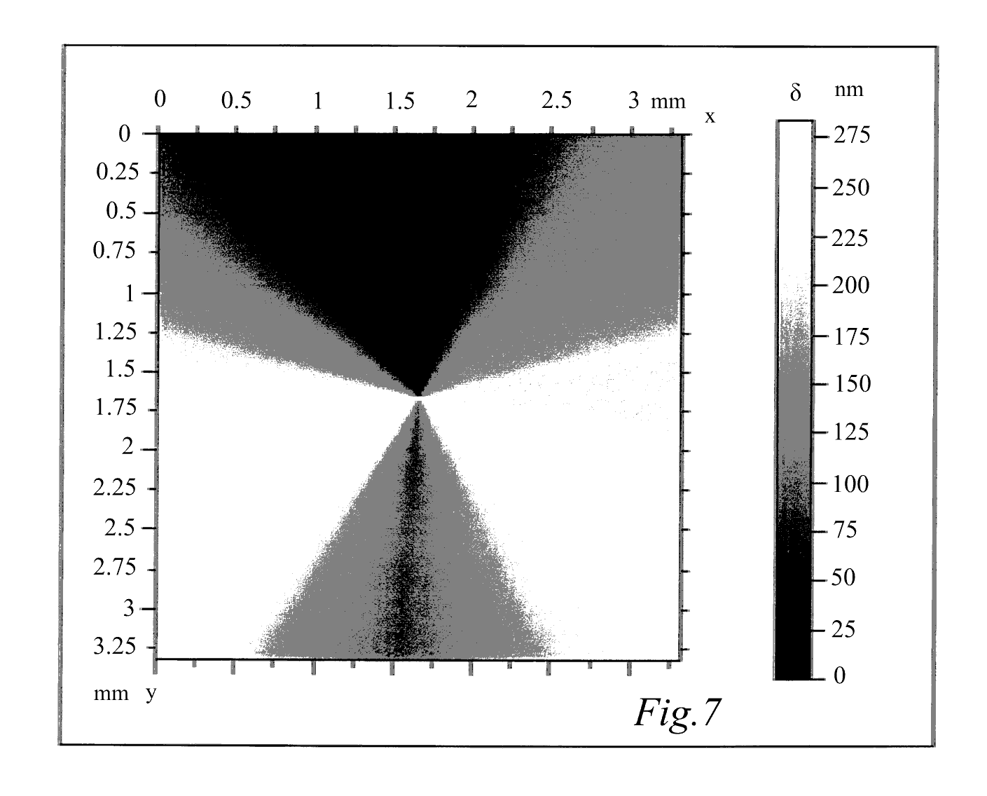

FIG. 7 shows a gray scale image representing scaled or expanded average data.

Referring now to the drawings, FIG. 1 shows a simplified schematic block diagram of metrological apparatus for determining a surface characteristic of a sample surface, for example roundness.

The apparatus 1 show in FIG. 1 is a coherence scanning apparatus having a coherence scanning interferometer system 2 based on a standard interferometer such as Michelson, Mirau or Linnik interferometer using a broadband spatially incoherent light source such as a quartz halogen lamp or LED light source, and a data processing and control apparatus 3.

Coherence scanning interferometry (CSI) or broadband scanning interferometry (sometimes called “white light scanning interferometry”) is discussed in a paper entitled “Profilometry with a Coherence Scanning Microscope” by Byron S. Lee and Timothy C. Strand published in Applied Optics, volume 29, number 26, 10 Sep. 1990 at pages 3784 to 3788, the whole contents of which are hereby incorporated by reference.

As shown in FIG. 1, the broadband light source 7 provides broadband light L which is directed by a beam splitter 8 to an objective lens assembly 9 having an objective lens 10 and a beam splitter 11 which directs light along a reference path RP towards a reference mirror 12 and along a sample path SP towards a surface 7 of a sample 8 mounted on a sample support stage 15. The objective lens 10 acts to focus light at the reference mirror 12 and sample surface. Light reflected from the reference mirror 12 returns along the reference path RP to the beam splitter 11 where it interferes with light reflected from the sample surface 7 back along the sample path SP. An image of the region of interference is focussed onto a detector 16.

The detector 16 has a 2-D (two-dimensional) array SA of image sensing elements SE, one array of which is shown very schematically in FIG. 1. Each individual sensing element SE detects the portion of the interference pattern falling within the acceptance cone of that element and resulting from a corresponding surface region or surface pixel of the area of the sample surface 7 so that, effectively, the imaged area of the surface can be considered as a 2-D array of surface regions or surface pixels.

A motion controller or Z mover 17 is provided to effect relative movement between the sample support stage 15 and the reference mirror 12. As shown in FIG. 1, the motion controller 17 is arranged to move the objective lens assembly 9, and thus the reference mirror 12, along the reference path RP. This is equivalent to moving the sample surface 7 along the scan path in the Z direction shown in FIG. 1. As another possibility, rather than moving the objective lens assembly 9, the sample support stage 15, and thus the sample 8, may be moved along the scan path (that is the direction Z in FIG. 1) to effect the relative movement between the sample 8 and the reference mirror 12. Operation of the Z mover 17 is effected under the control of a controller 21 of control apparatus 30 of the data processing and control apparatus 3. Movement in the Z direction of the objective lens assembly 9 is sensed by a Z position sensor 17a so to facilitate control by the controller 21 of the movement along the scan path. The Z position sensor 17a may be any suitable form of sensor, for example, a diffraction grating or other type of optical sensor, or as another example, a capacitive sensor.

The intensity of the illumination sensed by one sensing element SE varies as the scan path length difference changes with movement of the reference mirror 12 (or the sample 8), resulting in, for each surface area pixel, a series of interference fringes which have a coherence peak at the position along the scan path corresponding to a zero path length difference between the reference and sample paths. The relative positions along the Z direction (i.e. along the scan path) of the coherence peaks for different surface pixels thus provide a map of the relative surface heights of the surface pixels. These relative surface heights can be used to provide an indication of short wavelength surface characteristics such as surface texture or roughness and also of longer wavelength surface characteristics, for example roundness or straightness.

As shown in FIG. 1a, the broadband source 7 may be provided in a separate housing 4′ from the remainder of the interferometer 1′ and may be coupled to the remainder of the interferometer 1′ by means of a fibre optical coupling 4b. The remainder 1′ of the interferometer may be mounted within a housing to form a measurement head 2a which is supported by a carriage 18 movable along a reference column datum 19 in the Z direction in FIG. 1a. Movement of the carriage 18 in the Z direction may be effected by a further Z positioner 20 under the control of the controller 21. Movement of the carriage 18 in the Z direction may be sensed by a further Z position sensor 20a which may be any suitable form of sensor, for example an optical sensor. The housing 2a may be movable relative to the carriage 18 in the X direction in FIG. 1a by means of an X position driver (not shown) which may have an associated X position sensor (not shown).

Although not shown in FIG. 1, a support 150 carrying the turntable 15 may include a tip-tilt stage to enable the turntable 15 to be tilted in X and/or Y about the Z-axis. An example of a tip-tilt stage is described in, for example, U.S. Pat. No. 7,877,227, the whole contents of which are hereby incorporated by reference.

In the example described above, the objective lens assembly 9 is movable in the Z direction within the housing of the measurement head 2a. This need not necessarily be the case. Rather, movement in the Z direction may be effected simply by moving the measurement head 2a. In such a case, there would be only one Z mover and associated Z sensor, for example provided by the components labelled as the further Z positioner 20 and further Z sensor 20a in FIG. 1a.

Intensity data from the detector 16 is supplied to an intensity data receiver 33 of the data processing and control apparatus 3. The data processing and control apparatus 3 also has a data processor 32 for processing received intensity data and a user interface 31 for enabling a user to interact with and control measurement and data processing operations of the apparatus 1.

Examples of interferometer systems that may be used in the apparatus shown in FIG. 1 are disclosed in, for example, U.S. Pat. No. 7,385,707, U.S. Pat. No. 7,970,579, U.S. Pat. No. 7,440,116, U.S. Pat. No. 7,948,634, U.S. Pat. No. 7,518,733, U.S. Pat. No. 7,755,768, U.S. Pat. No. 7,697,726, the whole contents of each of which are hereby incorporated by reference. Other forms of interferometer system that are suitable for use in CSI may be used.

At least the controller 21 and data processor 32 of the data processing and control apparatus 3 may be implemented by programming computing apparatus, for example a personal computer. FIG. 2 shows a simplified block diagram of such computing apparatus. As shown, the computing apparatus has a processor 25 associated with memory 26 (ROM and/or RAM), a mass storage device 27 such as a hard disk drive, a removable medium drive (RMD) 28 for receiving a removable medium (RM) 29 such as a floppy disk, CD-ROM, DVD or the like, and input and output (I/O) controllers 37 for interfacing with components of the interferometer system 2 to be controlled by the control apparatus 30. The computing apparatus may have one or more input ports such as USB ports for enabling data communication with external devices. The user interface 31 may be provided by the computing apparatus and may consist of, for example, a keyboard 31a, a pointing device 31b, a display such as a CRT or LCD display 36a, and a printer 36b. The computing apparatus may include a communications interface (COMMS INT) 199 such as a MODEM or network card to enable the computing apparatus to communicate with other computing apparatus over a network such as the local area network (LAM), wide area network (LAN), an intranet or the Internet. In this example, the intensity data receiver 33 is provided as a dedicated frame capture circuit board 230 installed within the computing apparatus.

The computing apparatus may be programmed by, for example, any one or more of: program instructions stored in memory 26 and/or mass storage device 27; program instructions downloaded from a removable medium 29 and/or an external device coupled to an input port;

instructions input by a user using the user interface;
a signal SG received via the communications interface.

In the apparatus shown in FIG. 1, the sample support surface is a turntable 15 which is rotatable by means of a driver 50 which may be provided by any suitable form of motor drive. Rotation of the turntable is controlled by the controller 21. A sensor 50a may be provided to detect rotation of the turntable 15 and so facilitate control by the controller 21. The sensor 50a may be any suitable form of sensor, for example, a diffraction grating or other type of optical sensor. As another possibility a stepper motor that provides accurate steps of rotation may be used perhaps without the sensor 50a. As a further possibility, the turntable may be manually rotatable.

In the apparatus shown in FIG. 1, the data processor 32 provides a surface height determiner 319 configured to determine surface height data from image data received by the intensity data receiver 33, a measurement data store 320 configured to store measurement data, a form remover 322 configured to remove a nominal form of the surface being examined from the measurement data, if required, a data corrector 323 configured to obtain correction data, a scaler 321 configured to scale or expand the correction data, an correction data applier 324 configured to use the correction data to correct the measurement data and a display data provider 325 configured to provide display data for display on a display, for example the display 36a of the user interface 31. Although these components are shown as separate discrete components, it will be appreciated that this need not necessarily be the case and that the data processor may simply provide this functionality as one functional component or this functionality may be divided between two or more functional components.

An example of operation of this apparatus will now be described with the aid of the flowcharts shown in FIGS. 3 and 4 and with reference to the example display screenshots shown in FIGS. 5a to 7.

At step S1 in FIG. 3, a measurement operation is carried out. Thus, the workpiece 8 having the surface 7 to be measured, in this example the seating face of the valve cone of a fuel injector valve, is centred and leveled on the turntable 15 and the interferometry system 2 then activated. The detector 16 and/or the intensity data receiver 33 acquire images of the interference pattern as relative movement along the scan path (the Z direction in FIG. 1) is effected by the Z mover 17. Triggering of the detector 16 and/or the intensity data receiver 33 may be controlled by the controller 21 in response to signals provided by the Z position sensor 17a so that the detector 16 and intensity data receiver 33 capture interference pattern images at a selected or determined scan interval ΔZ along the scan path.

The conical seating face or surface under examination can be considered to have a height Z_{c} in the Z or scan direction. This height may be greater than or smaller than the extent of the Z scan path. If the height Z_{c} is greater than the extent of the Z scan path, then the height Z_{c} of the conical seating face may be scanned in two or more measurement sub-operations with the interferometer system being moved in the Z direction between sub-operations using the further Z positioner 20 and any appropriate data stitching algorithm used to align and stitch together in the Z direction the data obtained in those two or more steps, on the basis of the acquired data and outputs provided by the Z position sensor 17a and the further Z position sensor 20a.

Once the measurement operation has been completed, whether in a single scan or whether as a result of stitching together of data obtained in two or more measurement sub-operations, then the resulting frames of image data are analysed using any suitable analysis technique to determine the location along the scan path of the coherence peak for each surface region or pixel, thereby enabling the relative surface heights of different surface pixels to be determined. Examples of data analysis techniques to determine the coherence peaks and thence the relative surface heights of different surface pixels are described in U.S. Pat. No. 7,385,707, U.S. Pat. No. 7,970,579, U.S. Pat. No. 7,440,116, U.S. Pat. No. 7,948,634, U.S. Pat. No. 7,518,733, U.S. Pat. No. 7,755,768, U.S. Pat. No. 7,697,726, the whole contents of each of which were previously incorporated by reference. The resulting data is stored as measurement data at S2 in FIG. 3 in the measurement data store 320.

The component form remover 322 then carries out a fitting procedure to remove the best-fit form, in this case the frusto-conical form of the valve seating face, at S3 and the resulting residual data is then stored as form-removed data. A low pass filter, for example a Gaussian filter, may be used to remove features of a surface roughness or surface texture wavelength or scale prior to the fitting procedure. The resulting data may, for example, be displayed on the display 36a of the user output or printed by the printer 36b or supplied via the communications interface 199 to another computing apparatus where it may be displayed, printed or otherwise visually output to a user. For different nominal radii of the conical surface roundness plots may be output to the user in which deviations from roundness are represented as a variation in the radial direction from the circle defined by the nominal radius. As another possibility, the form-removed data may be represented on a false colour or grey scale roundness plot in which the deviation from the nominal radius is indicated by a false colour or a grey scale, so enabling the data for more than one radius to be represented on the same roundness plot. FIGS. 5a and 5b show grey scale roundness plots produced for measurement data obtained with the cone at two different angular orientations by rotating the turntable 15 upon which the cone is centred between measurement operations. In the example illustrated, the cone is oriented at a turntable rotation angle of 45° degrees (FIG. 5a) and a turntable rotation angle of 135° (FIG. 5b).

In FIGS. 5b and 5b the axes x and y are scaled in millimetres and represent the X and Y directions in FIG. 1 and the data shown are the form-removed data, that is the data after removal of the best fit cone or frusto-conical surface, projected onto a flat plane so that the data is represented as an annulus. The grey scale data is scaled in micrometers and represents the deviation δ in the radial direction from the nominal circle at that radius. The rotational axis of the form-fitted conical or frusto-conical surface will not necessarily coincide with the Z or optical axis of the interferometer and so the deviations δ may be deviations from the normal to the form-fitted conical or frusto-conical surface (ideal cone) rather than the Z axis and so may have a component inwards towards the axis of the surface as well as a component along the axis of the cone. As another possibility, the form-removed data maybe related to the Z axis rather than to the rotational axis of the form-fitted conical or frusto-conical surface.

A comparison of FIGS. 5a and 5b shows that the lower surface pixels (that is the pixels with a deviation height, δ, towards the bottom of the scale (i.e. towards 6=0) have a lower deviation δ when they are at the top and the bottom of the image than when they are not. Thus, the deviation δ (grey scale) data is not simply rotated by the amount by which the component was rotated between measurements but rather varies depending upon the actual relative rotational orientation of the component, that is the turntable rotation angle, when the measurement operation is carried out. In the example shown by FIGS. 5a and 5b, lower regions are measured as being deeper (lower in δ value) when they are at the top and bottom of the images. These variations with turntable rotation angle can result in inaccuracies in a roundness measurement because a surface pixel which is indicated by the measurement data to be at a particular height along the axis of the form-fitted conical or frusto-conical surface may not actually be at that height and so a roundness measurement nominally taken at a particular height along that axis may not actually represent the roundness at that actual height, because the relationship between the measured height and the actual height may depend upon the relative rotational orientation of the turntable and thus the workpiece when the measurement operation is carried out.

The present inventor has appreciated that these orientation-dependent effects are a result of optical distortions within the optical system of the interferometer, for example in the objective lens assembly 9, of the interferometer system 2.

In order to address this issue, at S4 in FIG. 3, once a measurement operation has been carried out with the turntable 15 at a rotational orientation (for example 0°) to obtain a measurement data set, then at S5 in FIG. 3, the turntable 15 is rotated (either manually or under the control of the controller 21) by a known angular rotation which is an integer divisor, n, of 360° and the procedures of S1 to S3 are carried out for that rotational orientation to obtain another form-removed measurement data set. The procedures of S5 and S1 to S3 are carried out at evenly spaced angular intervals to obtain respective form-removed measurement data sets until a full 360° rotation of the component has been achieved. At this point, form-removed measurement data sets will have been acquired for each of n rotational orientations of the turntable. As an example, the integer divisor, n, may be one of 24, 16, 12, 8, or 6 representing angular rotations of 15°, 22.5°, 30°, 45° or 60°, respectively. The angular rotation or integer divisor, n, may be selectable by the operator.

After the n measurement operations have been completed at S4 and n form-removed measurement data sets have been acquired, then at S6, the data corrector 323 uses the n form-removed measurement data sets to obtain correction data. In this example, the data corrector 323 averages the form-removed measurement data sets to produce, as the correction data, average form-removed data and stores this average form-removed data.

The workpiece on which the average form-removed data is obtained may be a standard sample, in which case the correction data may then simply be retained for later use in measurement operations on other workpieces. However, as shown in FIG. 3a, after obtaining the correction data, then at S7, the correction data applier 324 may access one or more of the previously stored form-removed measurement data sets from which the correction data was obtained and apply that correction data to that measurement data set. In this example, the correction data applier 324 remove the average data from that measurement data set to produce a modified or corrected form-removed measurement data in which the effect of distortions caused by the optics of the interferometer system has been removed or at least reduced. Where a standard sample is used, to assist in scattering light for detection by the optical measurement system it may be useful if the standard sample has features of surface roughness, for example a surface roughness of at least a micron.

Averaging of measurement data sets taken at a series of evenly spaced orientations around a full rotation of the turntable 15 results in the real roundness of the cone being populated around the roundness plot whereas the rotationally asymmetric distortion is in the same orientation. Accordingly, subtracting the average data from the form-removed measurement data for an orientation yields a corrected roundness plot for the component because the errors in the Z direction due to the optical system distortion are removed or at least reduced so enabling a more accurate determination of roundness at a particular actual height Z on the surface being examined. The corrected form-removed data may then be output to a user at S8. Outputting of the corrected form-removed data may involve representing the corrected form-removed data on a roundness plot which may be output to a user by, for example, being displayed on the display 36a of the user output or printed by the printer 36b or supplied via the communications interface 199 to another computing apparatus where it may be displayed, printed or otherwise visually output to a user.

FIGS. 6a and 6b show grey scale roundness plots similar to FIGS. 5a and 5b but where the data displayed is corrected form-removed measurement data. Thus, in this example, FIGS. 6a and 6b show roundness plots of the corrected form-removed measurement data produced from measurement data with the turntable (and thus the workpiece) at rotational orientations of 45° degrees and 135°, respectively. As can be seen from FIGS. 6a and 6b, the amplitudes of the low and high deviation δ regions are more consistent, that is they show less dependence upon the relative angular orientation of the workpiece.

As described above, the correction or average data is subtracted from measurement data obtained from the component under test. As another possibility or additionally, the average data may be retained by the data corrector 323 as calibration data for use in subsequent measurement operations. In this case, the component for which the correction data is obtained may be a well-defined standard component.

FIG. 4 shows a flow chart illustrating processes carried out where correction data has already been stored. At S10 a measurement operation is carried out as described above and at S11 the measurement data is stored. The expected form of the component is then removed at S12 and the resulting form-removed data is stored. At S13, the stored correction data may be scaled or expanded in a radial direction to ensure that the diameter range of the annulus representing the form-removed data is encompassed. In this example the expanded data is the deviation from a single circle in the middle of the roundness plot annulus expanded to extend from the centre to the edge of the surface. At S14 the stored correction data, scaled or expanded if necessary, is subtracted from the form-removed measurement data to obtain corrected or modified form-removed measurement data.

The scaling or expanding of the stored average data need not necessarily be carried out on-the-fly, rather, the data may be pre-scaled to allow its use for a range of annulus sizes by uniformly radially expanding the average data to produce radially expanded average data which may then be stored for later use. FIG. 7 shows a display screen shot similar to FIGS. 5A to 6B illustrating such radially expanded average data.

It will, of course, be appreciated that the measurement ranges or values shown in FIGS. 5a to 7 are only examples and that these measurement ranges will, of course, depend upon the workpiece (component) being measured. It will also be appreciated that the process described above may be used to measure the roundness of other nominally rotationally symmetric components than valve seating faces such as, for example other frusto-conical or conical surfaces. The surface may be an internal or external surface of the workpiece or component in question.

As described above, it is the workpiece that is rotated. It will, of course, be appreciated that the interferometer system may be mounted so as to be rotatable rather than the workpiece or, indeed, both interferometer system and the workpiece may be rotatable.

Although not mentioned above, a calibration step may be necessary or desirable prior to carrying out a measurement operation. Such a calibration may involve making measurements on an optical flat by tilting the optical flat first in the X and then in the Y direction (or vice versa) by appropriate rotation about the Y and X axes using the tip-tilt stage and for each measurement removing the average gradient and then recording the gradient-removed surface. The effectiveness of this calibration step is based on the assumption that X and Y can be calibrated independently of one another. Optical distortions, such as pincushion or barrel distortions in the optical system, can be separated into X and Y components. However, errors in the alignment of tilt in the Y and X directions may result in an interdependence of or “crosstalk” between X and Y which may detrimentally affect the calibration procedure. By removing the average central gradient, the present invention may however enable such issues to be ameliorated.

As described above, depending upon the range of the instrument and the distance in the Z direction over which measurement of a surface is required, a measurement operation may consist of two or more measurement sub-operations with relative movement being effected in the Z direction between sub-operations. Generally the optical system will be capable of imaging the entire X-Y extent of the surface under examination so that movement in the X and/or Y direction will not be necessary to image the surface under examination. However, although not shown in FIG. 1, the support 150 carrying the turntable 15 may be movable (by X and/or Y movers with appropriate sensors) relative to the optical axis (or, as another possibility the measurement head 2a may be movable in the X and/or Y directions relative to the turntable 15) to allow examination of surfaces having an extent in the X and/or Y direction greater than the area that can be imaged by the interferometer system 2. With such a system, it may be possible to scan a surface under examination in two or more measurement sub-operations with movement in the X and/or Y direction between measurement sub-operations and then to use an appropriate data stitching algorithm used to align and stitch together data in the X and/or Y directions, although correction for the optical distortions as discussed above may be desirable before aligning and stitching together of the data.

Although described above as being provided by programming one or more computing apparatus, the data processor may be a dedicated hardwired apparatus or a digital signal processor, for example or any combination of hardware, software and firmware.

Although the apparatus and method described above use a coherence scanning interferometer, it may be possible to apply the process described above to other optical measurement systems where rotationally asymmetric distortions or aberrations may be an issue.

In an embodiment there is provided a method of determining correction data for a second optical metrological apparatus comprising an optical measurement system. The method may comprise determining first correction data for a first metrological apparatus according to any one of the methods described herein, or those defined in the appended claims.

Embodiments of this method may comprise using the first metrological apparatus to measure a calibration sample, and correcting that measurement using the first correction data to provide calibration data for the calibration sample. To determine correction data for the second metrological apparatus, the calibration sample can be measured by the second metrological apparatus to obtain second measurement data. The correction data for the second metrological apparatus can then be determined based on the calibration data and the second measurement data, for example based on subtracting the calibration data from the second measurement data. This second metrological apparatus correction data can then be used for correcting measurements performed by the second metrological apparatus.

The calibration sample may be cone shaped, and may be of non-perfect roundness. The calibration sample may carry a reference mark for orienting the sample. The calibration sample can be aligned with respect to the second instrument based on the reference mark to be measured by the second instrument.

1. A metrological apparatus for determining a surface characteristic of a surface of a workpiece, the metrological apparatus comprising:
an optical measurement system to obtain measurement data representative of a surface of a workpiece;
a rotation device to effect relative rotation between the optical measurement system and the workpiece about a measurement axis to enable a plurality of measurement data sets to be obtained with each measurement data set being obtained by the optical measurement system at a respective one of a number of different relative rotational orientations of the optical measurement system and the workpiece; a correction data obtainer to use the plurality of measurement data sets to obtain correction data to enable correction of a measurement data set.

2. A metrological apparatus according to claim 1, further comprising a form data remover configured to fit a model of expected surface form to each of the plurality of measurement data sets to obtain corresponding fitted form data, and to adjust each measurement data set based on the corresponding fitted form data.

3. A metrological apparatus according to claim 1 or 2, further comprising a low pass filter configured to smooth the measurement data.

4. A metrological apparatus according to any preceding claim, wherein the correction data obtainer is arranged to average the plurality of measurement data sets to obtain the correction data.

5. A metrological apparatus according to any preceding claim, further comprising a correction data remover to remove the correction data from at least one measurement data set to obtain corrected measurement data.

6. A metrological apparatus according to claim 5, wherein the at least one measurement data set is one of the plurality of measurement data sets.

7. A metrological apparatus according to claim 5, wherein the at least one measurement data set is not one of the plurality of measurement data sets.

8. A metrological apparatus according to any preceding claim, wherein the surface characteristic is the roundness of the surface.

9. A metrological apparatus according to any of claims 1 to 7, wherein the measurement data comprises roundness measurement data.

10. A metrological apparatus according to any preceding claim, further comprising a correction data expander to expand the correction data to enable the correction data to be used for workpiece surfaces of different dimensions.

11. A metrological apparatus according to any preceding claim, wherein the rotation device comprises a turntable on which the workpiece is mounted during a measurement operation.

12. A metrological apparatus according to any preceding claim, wherein the optical measurement system is an interferometric measurement system.

13. A metrological apparatus according to any of claims 1 to 11, wherein the optical measurement system is a coherence scanning interferometric measurement system.

14. A metrological apparatus according to any of claims 1 to 11, wherein the optical measurement system comprises:
a light director to direct light along a sample path towards a region of the workpiece surface and along a reference path towards a reference surface such that light reflected by the region of the workpiece surface and light reflected by the reference surface interfere;
a mover to effect relative movement between the workpiece surface and the reference surface along a measurement path;
a sensor operable to sense light representing the interference fringes produced by workpiece surface regions during the relative movement; and
a controller to carry out a measurement operation by causing the mover to effect the relative movement while the sensor senses light intensity at intervals to provide, for each of a plurality of workpiece surface regions, a series of intensity values representing interference fringes produced by that workpiece surface region during the relative movement.

15. A metrological apparatus for determining surface roundness comprising a metrological apparatus according to any previous claim in which the measurement data comprises:
roundness data for at least a part of a surface of a workpiece and in which the rotation device is configured; and in which the correction data obtainer comprises:
a data averager to average the plurality of measurement data sets to obtain average measurement data to enable correction of a measurement data set for at least part of a surface.

16. A metrological apparatus according to claim 15, further comprising an average data remover to remove the average measurement data from at least one measurement data set to obtain corrected measurement data.

17. A metrological apparatus according to claim 16, wherein the at least one measurement data set is one of the plurality of measurement data sets.

18. A metrological apparatus according to claim 16, wherein the at least one measurement data set is not one of the plurality of measurement data sets.

19. A metrological apparatus according to any of claims 15 to 18, further comprising an average data expander to expand the average data to enable the average data to be used with workpiece surfaces of different dimensions.

20. A metrological apparatus according to any of claims 15 to 19, further comprising a form data remover configured to fit a model of expected surface form to each of the plurality of measurement data sets to obtain corresponding fitted form data, and to adjust each measurement data set based on the corresponding fitted form data.

21. A metrological apparatus according to any of claims 15 to 20, wherein the optical measurement system is an interferometric measurement system.

22. A metrological apparatus according to any of claims 15 to 20, wherein the optical measurement system is a coherence scanning interferometric measurement system.

23. A metrological apparatus according to any of claims 15 to 20, wherein the optical measurement system comprises:
a light director to direct light along a sample path towards a region of a workpiece surface and along a reference path towards a reference surface such that light reflected by the region of the workpiece surface and light reflected by the reference surface interfere;
a mover to effect relative movement between the workpiece surface and the reference surface along a measurement path;
a sensor operable to sense light representing the interference fringes produced by workpiece surface regions during the relative movement; and
a controller to carry out a measurement operation by causing the mover to effect the relative movement while the sensor senses light intensity at intervals to provide for, each of a plurality of workpiece surface regions, a series of intensity values representing interference fringes produced by that workpiece surface region during the relative movement.

24. A metrological apparatus for providing roundness measurement data for a sample surface comprising an apparatus according to claim 1, the optical measurement system comprising:
a light director to direct light along a sample path towards a region of a sample surface and along a reference path towards a reference surface such that light reflected by the region of the sample surface and light reflected by the reference surface interfere;
a mover to effect relative movement between the sample surface and the reference surface along a measurement path;
a sensor operable to sense light representing the interference fringes produced by sample surface regions during the relative movement; the apparatus further comprising:
a controller to carry out a measurement operation by causing the mover to effect the relative movement while the sensor senses light intensity at intervals to provide, for each of a plurality of sample surface regions, a series of intensity values representing interference fringes produced by that sample surface region during the relative movement such that a said series of intensity values has a coherence peak at a position along the measurement path representing a location of zero path difference between the reference path and the sample path for the corresponding sample surface region;
a surface height determiner to determine surface height data representing the relative surface heights of sample surface regions on the basis of the locations along the measurement path of their respective coherence peaks so as to provide a measurement data set comprising roundness measurement data; and in which the rotation device is configured to:
effect relative rotation between the optical measurement system and the sample surface about a measurement axis to enable a plurality of said measurement data sets to be obtained each comprising roundness data, with each measurement data set being obtained by the optical measurement system at a respective one of a number of different relative rotational orientations of the optical measurement system and the workpiece; and the correction data obtainer is configured to:
use the plurality of measurement data sets to obtain correction data to enable correction of a measurement data set.

25. A metrological apparatus according to claim 24, wherein the correction data obtainer is arranged to average the plurality of measurement data sets to obtain the correction data.

26. A metrological apparatus according to claim 24 or 25, further comprising a correction data remover to remove the correction data from at least one measurement data set to obtain corrected measurement data.

27. A metrological apparatus according to claim 26, wherein the at least one measurement data set is one of the plurality of measurement data sets.

28. A metrological apparatus according to claim 26, wherein the at least one measurement data set is not one of the plurality of measurement data sets.

29. A metrological apparatus according to any of claims 24 to 28, wherein a surface form remover is provided to remove a sample surface form from a said measurement data set to leave data indicative of any out-of-roundness of the surface of a section through the surface at one or more locations along an axis of the surface;

30. A metrological apparatus for determining a surface characteristic, for example roundness, of a surface of a workpiece, the metrological apparatus comprising:
an optical measurement system to obtain measurement data representative of a surface characteristic, for example roundness, of a surface of a workpiece or component; and a
data processor to remove from the measurement data correction data obtained by apparatus according to any preceding claim.

31. A method of determining a surface characteristic of a surface of a workpiece, the method comprising:
using an optical measurement system to carry out a plurality of measurement operations on a surface of a workpiece and effecting relative rotation between the optical measurement system and the workpiece about a measurement axis between measurement operations to obtain a plurality of measurement data sets with each measurement data set being obtained at a respective one of a number of different relative rotational orientations of the optical measurement system and the workpiece;
using the plurality of measurement data sets to obtain correction data to enable correction of a measurement data set.

32. A method according to claim 31, wherein obtaining the plurality of measurement data sets comprises fitting a model of expected surface form to each of the plurality of measurement data sets obtained by the optical measurement system to obtain corresponding fitted form data, and to adjust each measurement data set based on the corresponding fitted form data.

33. A method according to claim 31 or 32, wherein using the plurality of measurement data sets to obtain correction data comprises averaging the plurality of adjusted measurement data sets.

34. A method according to any of claims 31 to 33, further comprising removing the correction data from at least one measurement data set to obtain corrected measurement data.

35. A method according to claim 34, wherein the at least one measurement data set is one of the plurality of measurement data sets.

36. A method according to claim 34, wherein the at least one measurement data set is not one of the plurality of measurement data sets.

37. A method according to any of claims 31 to 36, wherein the surface characteristic is the roundness of the surface.

38. A method according to any of claims 31 to 37, wherein the measurement data comprises roundness measurement data.

39. A method according to any of claims 31 to 38, further comprising a correction data expander to expand the correction data to enable the correction data to be used for workpiece surfaces of different dimensions.

40. A method according to any of claims 31 to 39, wherein a rotation device comprises a turntable on which the workpiece is mounted during a measurement operation.

41. A method according to any of claims 31 to 40, wherein the optical measurement system is an interferometric measurement system.

42. A method according to any of claims 31 to 41, wherein the optical measurement system is a coherence scanning interferometric measurement system.

43. A method according to any of claims 31 to 42, wherein using an optical measurement system to carry out a measurement operation comprises:
directing light along a sample path towards a region of the workpiece surface and along a reference path towards a reference surface such that light reflected by the region of the workpiece surface and light reflected by the reference surface interfere;
effecting relative movement between the workpiece surface and the reference surface along a measurement path; and
sensing light representing the interference fringes produced by workpiece surface regions at intervals during the relative movement to provide, for each of a plurality of workpiece surface regions, a series of intensity values representing interference fringes produced by that workpiece surface region during the relative movement.

44. A method of determining surface roundness, comprising a method according to claim 31, determining surface roundness in which the measurement data comprises roundness data for at least part of a surface of the workpiece; in which using the plurality of measurement data sets comprises:
averaging the plurality of measurement data sets to obtain average measurement data to enable correction of a measurement data set for at least part of a surface.

45. A method according to claim 44, further comprising removing the average measurement data from at least one measurement data set to obtain corrected measurement data.

46. A method according to claim 45, wherein the at least one measurement data set is one of the plurality of measurement data sets.

47. A method according to claim 45, wherein the at least one measurement data set is not one of the plurality of measurement data sets.

48. A method according to any of claims 44 to 47, further comprising expanding the average data to enable the average data to be used with workpiece surfaces of different dimensions.

49. A method according to any of claims 44 to 48, further comprising fitting a model of expected surface form to each of the plurality of measurement data sets obtained by the optical measurement system to obtain corresponding fitted form data, and to adjust each measurement data set based on the corresponding fitted form data.

50. A method according to any of claims 44 to 49, wherein the optical measurement system is an interferometric measurement system.

51. A method according to any of claims 44 to 50, wherein the optical measurement system is a coherence scanning interferometric measurement system.

52. A method according to any of claims 44 to 50, wherein using an optical measurement system to carry out a measurement operation comprises:
directing light along a sample path towards a region of the workpiece surface and along a reference path towards a reference surface such that light reflected by the region of the workpiece surface and light reflected by the reference surface interfere;
effecting relative movement between the workpiece surface and the reference surface along a measurement path; and
sensing light representing the interference fringes produced by workpiece surface regions at intervals during the relative movement to provide, for each of a plurality of workpiece surface regions, a series of intensity values representing interference fringes produced by that workpiece surface region during the relative movement.

53. A method for providing roundness measurement data for a workpiece surface comprising a method according to claim 31, wherein carrying out a said plurality of measurement operations comprises:
directing light along a sample path towards a region of the workpiece surface and along a reference path towards a reference surface such that light reflected by the region of the workpiece surface and light reflected by the reference surface interfere, effecting relative movement between the workpiece surface and the reference surface along a measurement path, and
sensing light representing the interference fringes produced by workpiece surface regions at intervals during the relative movement to provide, for each of a plurality of workpiece surface regions, a series of intensity values representing interference fringes produced by that workpiece surface region during the relative movement such that a said series of intensity values has a coherence peak at a position along the measurement path representing a location of zero path difference between the reference path and the sample path for the corresponding sample surface region;
for each measurement operation determining surface height data representing the relative surface heights of sample surface regions on the basis of the locations along the measurement path of their respective coherence peaks so as to provide a measurement data set comprising roundness measurement data.

54. A method according to claim 53, wherein using the plurality of measurement data sets to obtain correction data comprises averaging the plurality of measurement data sets to obtain the correction data.

55. A method according to claim 53 or 54, further comprising removing the correction data from at least one measurement data set to obtain corrected measurement data.

56. A method according to claim 55, wherein the at least one measurement data set is one of the plurality of measurement data sets.

57. A method according to claim 55, wherein the at least one measurement data set is not one of the plurality of measurement data sets.

58. A method according to any of claims 53 to 57, further comprising removing a workpiece surface form from a said measurement data set to leave data indicative of any out-of-roundness of the surface of a section through the surface at one or more locations along an axis of the surface;

59. A method of determining a surface characteristic, for example roundness, of a surface of a workpiece, the method comprising:
using an optical measurement system to obtain measurement data representative of a surface characteristic, for example roundness, of a surface of a workpiece or component; and a
removing from the measurement data correction data obtained by a method according to any of claims 31 to 58.

60. A data processor for a metrological apparatus, the data processor being configured:
to receive data for a plurality of measurement operations of a surface of a workpiece carried out by an optical measurement system with relative rotation between the optical measurement system and the workpiece about a measurement axis between measurement operations;
to determine for each measurement operation a corresponding measurement data set such that each measurement data set corresponds to a respective different one of a number of different relative rotational orientations of the optical measurement system and the workpiece; and
to use the plurality of measurement data sets to obtain correction data to enable correction of a measurement data set.

61. A data processor according to claim 60, wherein the data processor is configured to average the plurality of measurement data sets to obtain the correction data.

62. A data processor according to claim 60 or 61, wherein the data processor is configured to remove the correction data from at least one measurement data set to obtain corrected measurement data.

63. A data processor according to claim 62, wherein the at least one measurement data set is one of the plurality of measurement data sets.

64. A data processor according to claim 62, wherein the at least one measurement data set is not one of the plurality of measurement data sets.

65. A data processor according to any of claims 60 to 64, wherein the surface characteristic is the roundness of the surface.

66. A data processor according to any of claims 60 to 65, wherein the data processor is configured to expand the correction data to enable the correction data to be used for workpiece surfaces of different dimensions.

67. A data processor according to any of claims 60 to 66, wherein the data processor is configured to fit a model of expected surface form to each of a plurality of measurement data sets, to obtain corresponding fitted form data, and to adjust each measurement data set based on the corresponding fitted form data.

68. A method of determining a surface characteristic, the method comprising:
using an optical measurement system of a first metrological apparatus to carry out a plurality of measurement operations on a surface of a first workpiece and effecting relative rotation between the optical measurement system and the first workpiece about a measurement axis between measurement operations to obtain a plurality of measurement data sets with each measurement data set being obtained at a respective one of a number of different relative rotational orientations of the optical measurement system and the first workpiece;
using the plurality of measurement data sets to obtain first correction data for the first metrological apparatus;
using the first metrological apparatus to carry out a measurement of a calibration sample, and correcting that measurement using the first correction data to provide calibration data for the calibration sample
using a second metrological apparatus to measure the calibration sample to obtain second measurement data;
and determining second correction data for the second metrological apparatus based on the second measurement data and the calibration data to enable a surface characteristic of a second workpiece to be determined by the second metrological apparatus.

69. The method of claim 68 wherein determining second correction data comprises subtracting the first correction data from the first measurement data.

70. The method of claim 68 or 69 wherein the calibration sample is cone shaped.

71. The method of any of claims 68 to 70 wherein the calibration sample comprises is elliptical, eccentric, or otherwise deviates from roundness by more than the measurement accuracy of the first or second metrological apparatus.

72. The method of any of claims 68 to 71 wherein the calibration sample carries an orientation identifier for orienting the calibration sample, the method further comprising aligning the calibration sample with respect to the second instrument based on the orientation identifier.

73. The method of claim 72, wherein the orientation identifier comprises at least one of a reference mark, a shaped mounting, wherein the shape has a known asymmetry, and a known non-rotationally symmetric component of the calibration sample.

74. The method of any of claims 68 to 73 further comprising the features of any of claims 32 to 59.

75. A computer program product comprising program instructions that when executed by computing apparatus cause the computing apparatus to carry the method of any of claims 31 to 59.

76. A computer program product according to claim 75 in the form of at least one of a storage medium and a signal.

77. A non-transitory storage medium storing instructions that when executed by computing apparatus cause the computing apparatus to carry the method of any of claims of any of claims 31 to 59.
